(19) United States
(12) Patent Application Publication
(10) Pub. No.: US 2021/0200108 A1
(43) Pub. Date: Jul. 1, 2021

(54) ELECTROPHOTOGRAPHIC PHOTOSENSITIVE MEMBER, PROCESS CARTRIDGE, AND ELECTROPHOTOGRAPHIC APPARATUS

(71) Applicant: CANON KABUSHIKI KAISHA, Tokyo (JP)

(72) Inventors: Yota Ito, Tokyo (JP); Akira Sakakibara, Shizuoka (JP)

(21) Appl. No.: 17/129,161

(22) Filed: Dec. 21, 2020

(30) Foreign Application Priority Data
Dec. 27, 2019 (JP) 2019-239736

(51) Int. Cl. G03G 5/14; C08L 77/00; C08K 3/22; C08K 9/06; G03G 5/04; G03G 21/18

(52) U.S. Cl. CPC G03G 5/144; C08L 77/00; C08K 3/22; C08K 2003/2237; G03G 5/04; G03G 21/1814; C08K 9/06

(57) ABSTRACT

An electrophotographic photosensitive member includes: a support, an undercoat layer, and a photosensitive layer in this order, wherein the undercoat layer comprises a polyamide resin, and titanium oxide particles having been subjected to a surface treatment with an organic silicon compound, when an average primary particle size of the titanium oxide particles having been subjected to the surface treatment with the organic silicon compound is defined as “b” [μm], and a mass ratio of a Si element to TiO₂ in the titanium oxide particles having been subjected to the surface treatment with the organic silicon compound is defined as “c” [mass %], “b” and “c” satisfy a relationship expressed by the following Expression (B), 0.025≤b×c≤0.050, and the photosensitive layer is a monolayer type photosensitive layer comprising a charge generating substance, a hole transporting substance, and an electron transporting substance.

### BACKGROUND OF THE INVENTION

### Field of the Invention

The present invention relates to an electrophotographic photosensitive member, a process cartridge including the electrophotographic photosensitive member, and an electrophotographic apparatus including the electrophotographic photosensitive member.

### Description of the Related Art

An electrophotographic photosensitive member containing an organic photoconductive substance (charge generating substance) has been used as an electrophotographic photosensitive member mounted in a process cartridge or an electrophotographic apparatus. In general, an electrophotographic photosensitive member includes a support and a photosensitive layer formed on the support, and the photosensitive layer is classified into a monolayer type photosensitive layer formed of a single layer and a laminate type photosensitive layer formed of a charge generation layer and a charge transport layer formed on the charge generation layer. An electrophotographic photosensitive member including a monolayer type photosensitive layer has a lower production cost due to a simple layer structure as compared to that of an electrophotographic photosensitive member including a laminate type photosensitive layer, and is excellent in high resolution due to generation of charges in the vicinity of a surface of the photosensitive layer.

In addition, in order to enhance an adhesive force between the support and the photosensitive layer and to suppress injection of the charges from the support to the photosensitive layer and thus to suppress fogging and leakage due to a deterioration in a local charging performance, an undercoat layer is provided between the support and the photosensitive layer in many cases. In particular, recently, an electrophotographic photosensitive member having a long lifespan is desired, and an electrophotographic photosensitive member including an undercoat layer capable of achieving suppression of charge accumulation and suppression of both fogging and leakage at a high level even after long-term repeated use is required.

An undercoat layer in which titanium oxide particles are dispersed in a polyamide resin is used as the undercoat layer capable of suppressing the injection of the charges from the support to the photosensitive layer and suppressing the fogging and the leakage due to the deterioration in the local charging performance.

In the case of the electrophotographic photosensitive member including the monolayer type photosensitive layer, a content of a charge generating substance in the photosensitive layer is larger than that in the electrophotographic photosensitive member including the laminate type photosensitive layer, and a hole transporting substance and an electron transporting substance are contained in one layer. Therefore, the fogging and the leakage are likely to occur due to the deterioration in the local charging performance. In particular, the fogging and the leakage due to the deterioration in the local charging performance are likely to occur under a high-temperature and high-humidity environment. Therefore, a technology for suppressing fogging and leakage due to a deterioration in a local charging performance by performing a surface treatment on the titanium oxide particle contained in the undercoat layer to suppress resistance of titanium oxide and thus to suppress resistance of the undercoat layer is used.

However, in a case where an undercoat layer for suppressing fogging and leakage that occur under a high-temperature and high-humidity environment is provided, in the electrophotographic photosensitive member including the monolayer type photosensitive layer, sensitivity is reduced under a low-temperature and low-humidity environment.

Japanese Patent Application Laid-Open No. 2010-230746 describes that in an electrophotographic photosensitive member including a monolayer type photosensitive layer, a surface of a titanium oxide particle contained in an undercoat layer is subjected to an inorganic treatment or an organic treatment. In particular, as the organic treatment, a technology for adjusting a ratio of an organic silicon compound is described.

As a result of studies conducted by the inventors of the present invention, it was found that in the electrophotographic photosensitive member including the monolayer type photosensitive layer disclosed in Japanese Patent Application Laid-Open No. 2010-230746, a potential variation is not sufficiently suppressed in long-term repeated use under a low-temperature and low-humidity environment.

### SUMMARY OF THE INVENTION

An object of the present invention is to provide an electrophotographic photosensitive member capable of implementing both suppression of fogging under a high-temperature and high-humidity environment and suppression of a potential variation under a low-temperature and low-humidity environment in long-term repeated use. Another object of the present invention is to provide a process cartridge including the electrophotographic photosensitive member, and an electrophotographic apparatus including the electrophotographic photosensitive member.

According to an aspect of the present invention, an electrophotographic photosensitive member comprises: a support, an undercoat layer, and a photosensitive layer in this order, wherein the undercoat layer comprises: a polyamide resin, and titanium oxide particles having been subjected to a surface treatment with an organic silicon compound, when an average primary particle size of the titanium oxide particles having been subjected to the surface treatment with the organic silicon compound is defined as “b” [μm], and a mass ratio of a Si element to TiO₂ in the titanium oxide particles having been subjected to the surface treatment with the organic silicon compound is defined as “c” [mass %], “b” and “c” satisfy a relationship expressed by the following Expression (B),

0.025≤b×c≤0.050 (B), and

the photosensitive layer is a monolayer type photosensitive layer comprising: a charge generating substance, a hole transporting substance, and an electron transporting substance.

According to another aspect of the present invention, a process cartridge integrally supports: the electrophotographic photosensitive member, and at least one unit selected from the group consisting of a charging unit, a developing unit, and a cleaning unit, and the process cartridge is detachably attachable to a main body of an electrophotographic apparatus.

According to still another aspect of the present invention, an electrophotographic apparatus comprises: the electrophotographic photosensitive member, a charging unit, an exposing unit, a developing unit, and a transfer unit.

There is provided an electrophotographic photosensitive member capable of implementing both suppression of fogging under a high-temperature and high-humidity environment and suppression of a potential variation under a low-temperature and low-humidity environment in long-term repeated use. In addition, there are provided a process cartridge including the electrophotographic photosensitive member and an electrophotographic apparatus including the electrophotographic photosensitive member.

Further features of the present invention will become apparent from the following description of exemplary embodiments with reference to the attached drawings.

### BRIEF DESCRIPTION OF THE DRAWINGS

FIG. 1 is a view illustrating an example of a layer configuration of an electrophotographic photosensitive member.

FIG. 2 is a view illustrating a schematic configuration of an electrophotographic apparatus including a process cartridge including the electrophotographic photosensitive member.

### DESCRIPTION OF THE EMBODIMENTS

Preferred embodiments of the present invention will now be described in detail in accordance with the accompanying drawings.

An electrophotographic photosensitive member according to the present invention includes a support, an undercoat layer, and a photosensitive layer in this order, wherein the undercoat layer contains a polyamide resin and titanium oxide particles having been subjected to a surface treatment with an organic silicon compound, when an average primary particle size of the titanium oxide particles having been subjected to the surface treatment with the organic silicon compound is defined as “b” [μm], and a mass ratio of a Si element to TiO₂ in the titanium oxide particles having been subjected to the surface treatment with the organic silicon compound is defined as “c” [mass %], “b” and “c” satisfy a relationship expressed by the following Expression (B), 0.025≤b×c≤0.050 (B), and the photosensitive layer is a monolayer type photosensitive layer containing a charge generating substance, a hole transporting substance, and an electron transporting substance.

The inventors of the present invention presume the reason that both the fogging under the high-temperature and high-humidity environment and the potential variation under the low-temperature and low-humidity environment can be suppressed in the long-term repeated use of the electrophotographic photosensitive member as follows.

An undercoat layer in which titanium oxide particles are dispersed in a polyamide resin has been used. A surface of the titanium oxide particle is subjected to an inorganic treatment or an organic treatment, such that a hydroxyl group present on the surface of the titanium oxide particle can be reduced to impart hydrophobicity. Studies have been conducted to obtain a desired undercoat layer by enhancing dispersibility of the titanium oxide particles in the polyamide resin and appropriately adjusting a state of the surface of the titanium oxide particle through these surface treatments.

As described above, in the case of the electrophotographic photosensitive member including the monolayer type photosensitive layer, fogging and leakage due to a deterioration in a local charging performance are likely to occur in comparison to the case of the electrophotographic photosensitive member including the laminate type photosensitive layer. Therefore, the fogging and the leakage due to the deterioration in the local charging performance have been suppressed by performing the surface treatment on the titanium oxide particle.

At a portion that has not undergone an exposing process after charging, a substance that transports a charge having the same polarity as that of a charge applied to the photosensitive layer (for example, a hole transporting substance in a case of a positive charge) is present at an interface between the photosensitive layer and the undercoat layer, such that the charges are easily drawn to the undercoat layer. The drawing of the charges to the undercoat layer is one of the causes of the fogging. Here, the substance that transports the charge having the same polarity as that of the charge applied to the photosensitive layer serves as a carrier excited from the charge generating substance of the photosensitive layer.

On the other hand, at a portion that has undergone an exposing process after charging, a potential variation is suppressed by drawing of the charges to the undercoat layer due to the presence of a substance that transports a charge having the same polarity as that of a charge applied to the photosensitive layer at an interface between the photosensitive layer and the undercoat layer.

When the suppression of the fogging under the high-temperature and high-humidity environment is emphasized, resistance of the undercoat layer is increased. Therefore, the titanium oxide particles are subjected an excessive surface treatment from the viewpoint of suppressing the potential variation under the low-temperature and low-humidity environment. In order to suppress both the fogging under the high-temperature and high-humidity environment and the potential variation under the low-temperature and low-humidity environment, it is necessary not to excessively increase the resistance of the undercoat layer. The inventors of the present invention focused on amass ratio of a Si element to TiO₂ in the titanium oxide particles having been subjected to the surface treatment with the organic silicon compound as a degree of the surface treatment.

An average primary particle size of the titanium oxide particles having been subjected to the surface treatment with the organic silicon compound is defined as “b” [μm], and a mass ratio of the Si element to the TiO₂ in the titanium oxide particles having been subjected to the surface treatment with the organic silicon compound is defined as “c” [mass %]. In this case, “b” and “c” satisfy a relationship expressed by the following Expression (B), such that both the fogging under the high-temperature and high-humidity environment and the potential variation under the low-temperature and low-humidity environment can be suppressed.

0.025≤b×c≤0.050 (B)

Since an inequality of Expression (B) is derived based on the above considerations, it is established only in a case where the photosensitive layer included in the electrophotographic photosensitive member is a monolayer type photosensitive layer containing a charge generating substance, a hole transporting substance, and an electron transporting substance. In a case where the photosensitive layer is a laminate type photosensitive layer, since the substance that transports the charge having the same polarity as that of the charge applied to the photosensitive layer (for example, a hole transporting substance in a case of a positive charge) is not present at the interface between the undercoat layer and the charge generating layer adjacent to the undercoat layer, the effects of the present invention are not sufficiently obtained in some cases.

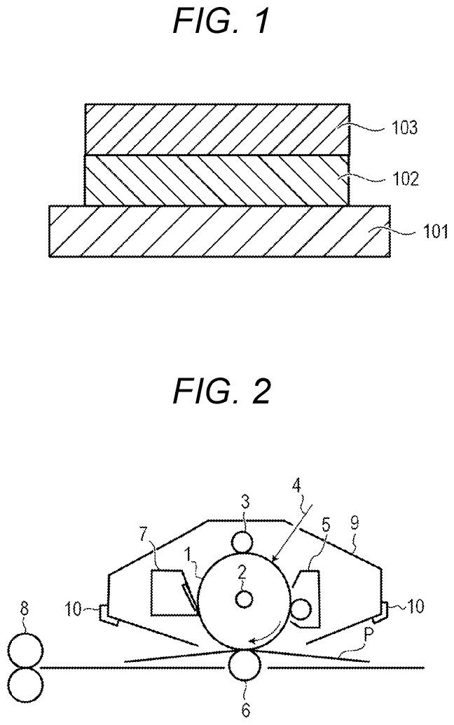

FIG. 1 is a view illustrating an example of a layer configuration of an electrophotographic photosensitive member according to the present invention. In FIG. 1, the electrophotographic photosensitive member includes a support 101, an undercoat layer 102, and a photosensitive layer 103 in this order.

Support

A support having electroconductivity (electroconductive support) is preferred as the support. For example, a support formed of a metal such as aluminum, iron, nickel, copper, or gold or a metal alloy thereof can be used. In addition, an example of the support can include a support in which a thin metal film such as aluminum, chromium, silver, or gold, or a thin film formed of an electroconductive material such as indium oxide or tin oxide is formed on an insulating support formed of a polyester resin, a polycarbonate resin, a polyimide resin, or glass. A surface of the support may be subjected to an electrochemical treatment such as anodization, a wet honing treatment, a blast treatment, or a cutting treatment to improve electrical characteristics or to suppress an interference fringe.

Electroconductive Layer

In the present invention, an electroconductive layer may be provided on the support. By providing the electroconductive layer, scratches or unevenness on the surface of the support can be concealed, or reflection of light on the surface of the support can be controlled.

The electroconductive layer preferably contains an electroconductive particle and a resin.

Examples of a material for the electroconductive particle can include a metal oxide, a metal, and carbon black.

Examples of the metal oxide can include zinc oxide, aluminum oxide, indium oxide, silicon oxide, zirconium oxide, tin oxide, titanium oxide, magnesium oxide, antimony oxide, and bismuth oxide. Examples of the metal can include aluminum, nickel, iron, nichrome, copper, zinc, and silver.

Among them, the metal oxide is preferably used for the electroconductive particle. In particular, titanium oxide, tin oxide, or zinc oxide is more preferably used for the electroconductive particle.

In a case where the metal oxide is used for the electroconductive particle, a surface of the metal oxide may be treated with a silane coupling agent or the like, or the metal oxide may be doped with an element such as phosphorus or aluminum, or an oxide thereof.

In addition, the electroconductive particle may have a laminate structure having a core particle and a covering layer that covers the core particle. Examples of a material of the core particle can include titanium oxide, barium sulfate, and zinc oxide. Examples of a material for the covering layer can include a metal oxide such as tin oxide.

In addition, in a case where the metal oxide is used for the electroconductive particle, a volume average particle size thereof is preferably 1 nm or more and 500 nm or less and more preferably 3 nm or more and 400 nm or less.

Examples of the resin can include a polyester resin, a polycarbonate resin, a polyvinyl acetal resin, an acrylic resin, a silicone resin, an epoxy resin, a melamine resin, a polyurethane resin, a phenol resin, and an alkyd resin.

In addition, the electroconductive layer may further contain a masking agent such as silicone oil, a resin particle, or titanium oxide.

An average film thickness of the electroconductive layer is preferably 1 μm or more and 50 μm or less and particularly preferably 3 μm or more and 40 μm or less.

The electroconductive layer can be formed by preparing a coating liquid for an electroconductive layer containing the above-described respective materials and a solvent, forming a coating film thereof, and drying the coating film. Examples of the solvent used in the coating liquid can include an alcohol-based solvent, a sulfoxide-based solvent, a ketone-based solvent, an ether-based solvent, an ester-based solvent, and an aromatic hydrocarbon-based solvent. Examples of a method for dispersing the electroconductive particles in the coating liquid for an electroconductive layer can include methods using a paint shaker, a sand mill, a ball mill, and a liquid collision-type high-speed disperser.

Undercoat Layer

An undercoat layer is provided between the support or the electroconductive layer and the photosensitive layer.

The undercoat layer contains a polyamide resin and titanium oxide particles having been subjected to a surface treatment with an organic silicon compound. In addition, when an average primary particle size of the titanium oxide particles having been subjected to the surface treatment with the organic silicon compound is defined as “b” [μm], and a mass ratio of a Si element to TiO₂ in the titanium oxide particles having been subjected to the surface treatment with the organic silicon compound is defined as “c” [mass %], “b” and “c” satisfy the relationship expressed by Expression (B).

A polyamide resin which is soluble in an alcohol-based solvent is preferred as the polyamide resin. For example, ternary (6-66-610) copolymerized polyamide, quaternary (6-66-610-12) copolymerized polyamide, N-methoxymethylated nylon, polymerized fatty acid-based polyamide, a polymerized fatty acid-based polyamide block copolymer, copolymerized polyamide having a diamine component, or the like is preferably used.

The titanium oxide particle preferably has a crystal system of a rutile-type or an anatase-type, and more preferably has a crystal system of a rutile-type which is weak in photocatalytic activity, from the viewpoint of suppressing the potential variation. In the case of the rutile-type, a rutile ratio is preferably 90% or more.

A shape of the titanium oxide particle is preferably a spherical shape. It is preferable that the average primary particle size b [μm] of the titanium oxide particles satisfies 0.01≤b≤0.05 from the viewpoint of suppressing both the fogging under the high-temperature and high-humidity environment and the potential variation under the low-temperature and low-humidity environment. Examples of the organic silicon compound used for the surface treatment of the titanium oxide particles can include a compound represented by the following Formula (S1) and a compound represented by the following Formula (S2).

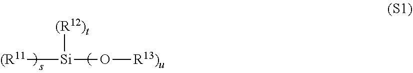

wherein R¹¹ represents a hydrogen atom, a vinyl group, a substituted or unsubstituted alkyl group, or a substituted or unsubstituted aryl group; in a case where R¹¹ is a substituted alkyl group or a substituted aryl group, a substituent which each of the alkyl group and the aryl group may have is an amino group, a vinyl group, an epoxy group, a glycidoxy group, a methacryloyl group, or a trifluoromethyl group; R¹² represents a hydrogen atom or a methyl group; R¹³ represents a methyl group or an ethyl group; and s+t+u=4, in which s is an integer of 1 or more, t is an integer of 0 or more, and u is an integer of 2 or more, where R¹² is not present when s+u=4.

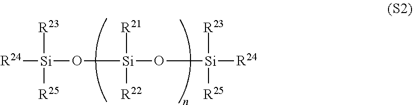

wherein each of R²¹ to R²⁵ represents a hydrogen atom, a substituted or unsubstituted alkyl group, or a substituted or unsubstituted aryl group; where both R²¹ and R²² are not a hydrogen atom, and all of R²³ to R²⁵ are not a hydrogen atom; in a case where each of R²¹, R²², R²³, R²⁴, and R²⁵ is a substituted alkyl group or a substituted aryl group, a substituent which each of the alkyl group and the aryl group may have is an amino group, a hydroxyl group, a carboxyl group, a mercapto group, an epoxy group, a glycidoxy group, and a trifluoromethyl group; and n is an integer of 0 or more.

A hydrophobized degree of the titanium oxide particles having been subjected to the surface treatment with the organic silicon compound is defined as α [%]. In this case, when the hydrophobized degree α [%] is 35% or more and 85% or less, both the fogging under the high-temperature and high-humidity environment and the potential variation under the low-temperature and low-humidity environment can be suppressed at a high level.

As a method of performing the surface treatment on the titanium oxide particles with the organic silicon compound, a dry method that does not use an organic solvent other than the organic silicon compound and the titanium oxide particles or a wet method using an organic solvent may be used, and any method may be used as long as “b” and “c” satisfy Expression (B).

When the amount of titanium oxide particles used for the surface treatment of the organic silicon compound is relatively large, a ratio of the amount actually surface-treated (a value of “c”) to the prepared amount may vary depending on a surface treatment method. In order to satisfy both a preferred range of the hydrophobized degree of the titanium oxide particles having been subjected to the surface treatment and the relationship expressed by Expression (B), it is required to select an appropriate surface treatment method.

In addition, the titanium oxide particles may be subjected to a surface treatment with an inorganic material before the surface treatment with the organic silicon compound, but it is preferable that the titanium oxide particles are not subjected to the surface treatment with the inorganic material. In a case where the titanium oxide particles are subjected to a surface treatment with an inorganic material containing a Si element, the titanium oxide particles having been subjected to the surface treatment used for forming the undercoat layer are required to be subjected to a treatment to satisfy the relationship expressed by Expression (B).

Specifically, the organic silicon compound used for the surface treatment is the compound represented by Formula (S1), and is more preferably at least one selected from vinyltrimethoxysilane, vinyltriethoxysilane, vinylmethyldimethoxysilane, n-propyltrimethoxysilane, and isobutyltrimethoxysilane.

When a ratio of a volume of the titanium oxide particles to a volume of the polyamide resin in the undercoat layer is defined as “a”, it is preferable that “a” and “b” satisfy a relationship expressed by the following Expression (A). Therefore, both the fogging under the high-temperature and high-humidity environment and the potential variation under the low-temperature and low-humidity environment can be suppressed at a high level.

12.5≤a/b≤16.0 Expression (A)

A film thickness d [μm] of the undercoat layer is preferably 1.0 μm or more and 3.0 μm or less. When the film thickness d is within the above range, both a high effect of suppressing fogging under a high-temperature and high-humidity environment and a high effect of suppressing a potential variation under a low-temperature and low-humidity environment can be obtained.

The undercoat layer may contain an additive such as organic particles or a leveling agent in addition to the polyamide resin and the titanium oxide particles in order to prevent an interference fringe and to increase film formability of the undercoat layer. Here, a content of the additive in the undercoat layer is preferably 10 mass % or less with respect to a total mass of the undercoat layer.

Photosensitive Layer

A photosensitive layer is provided directly on the undercoat layer.

The photosensitive layer is a monolayer type photosensitive layer containing a charge generating substance, a hole transporting substance, and an electron transporting substance.

Examples of the charge generating substance used in the photosensitive layer can include an azo pigment, a perylene pigment, an anthraquinone derivative, an anthanthrone derivative, a dibenzpyrenequinone derivative, a pyranthrone derivative, a violanthrone derivative, an isoviolanthrone derivative, an indigo derivative, a thioindigo derivative, a phthalocyanine pigment such as metal phthalocyanine or metal-free phthalocyanine, and a bisbenzimidazole derivative. Among them, a phthalocyanine pigment is preferred. Among the phthalocyanine pigments, oxytitanium phthalocyanine, chlorogallium phthalocyanine, or hydroxygallium phthalocyanine is preferred.

Examples of the hole transporting substance used in the photosensitive layer can include a polycyclic aromatic compound, a heterocyclic compound, a hydrazone compound, an enamine compound, a stilbene compound, a styryl compound, a benzidine compound, a triarylamine compound, and triphenylamine. In addition, a polymer having a group derived from these compounds at a main chain or a side chain can also be used as the hole transporting substance used in the photosensitive layer.

Examples of the electron transporting substance used in the photosensitive layer can include a naphthalene tetracarboxylic acid diimide compound, a perylene tetracarboxylic acid diimide compound, a diphenoquinone compound, an anthraquinone compound, a naphthoquinone compound, a phenanthrenequinone compound, a phenanthroline compound, an acenaphthoquinone compound, a tetracyanoquinodimethane compound, a fluorenone compound, a benzophenone compound, and a xanthone compound. In addition, a polymer having a group derived from these compounds at a main chain or a side chain can also be used as the electron transporting substance used in the photosensitive layer.

In particular, the electron transporting substance used in the photosensitive layer is preferably a compound represented by the following Formula (S7).

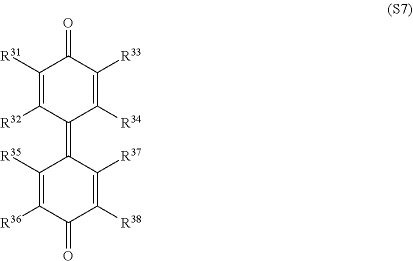

wherein each of R³¹ to R³⁸ represents a hydrogen atom, a halogen atom, an alkyl group which may be substituted with a halogen atom, an aryl group which may be substituted with a halogen atom, or an alkoxy carbonyl group which may be substituted with a halogen atom, or R³¹ and R³², R³³ and R³⁴, R³⁵ and R³⁶, or R³⁷ and R³⁸ may be bonded to each other to form an aromatic ring which may be substituted with an alkyl group.

The photosensitive layer preferably contains a binder resin.

Examples of the binder resin used in the photosensitive layer can include a polyester resin, a polycarbonate resin, a polymethacrylic acid ester resin, a polyarylate resin, a polysulfone resin, and a polystyrene resin. Among them, a polycarbonate resin or a polyarylate resin is preferred. A weight average molecular weight of the binder resin is preferably within a range of 10,000 or more and 300,000 or less.

In the photosensitive layer, a mass ratio of the charge generating substance to the binder resin (charge generating substance/binder resin) is preferably within a range of 0.005 or more and 0.250 or less and more preferably within a range of 0.020 or more and 0.100 or less.

A mass ratio of the hole transporting substance to the binder resin (hole transporting substance/binder resin) is preferably within a range of 0.2 or more and 1.2 or less and more preferably within a range of 0.4 or more and 0.9 or less.

A mass ratio of the electron transporting substance to the binder resin (electron transporting substance/binder resin) is preferably within a range of 0.1 or more and 1.0 or less and more preferably within a range of 0.2 or more and 0.7 or less.

In addition, the photosensitive layer may contain an antioxidant such as hindered phenol to prevent a deterioration from gas such as O₃ or NOₓ generated during the charging. In addition, the photosensitive layer may contain a leveling agent such as silicone oil to improve film formability of the photosensitive layer.

Examples of the solvent used in the coating liquid for a photosensitive layer can include an alcohol-based solvent, a sulfoxide-based solvent, a ketone-based solvent, an ether-based solvent, an ester-based solvent, and an aromatic hydrocarbon solvent.

The photosensitive layer preferably has a film thickness of 10 μm or more and 50 μm or less and more preferably 20 μm or more and 40 μm or less.

As a method of forming the respective layers constituting the electrophotographic photosensitive member such as the undercoat layer and the photosensitive layer, the following method is preferred. That is, the method includes applying a coating liquid obtained by dissolving and/or dispersing materials constituting the respective layers in a solvent to form a coating film, and drying and/or curing the obtained coating film. Examples of a method of applying the coating liquid can include a dip coating method, a spray coating method, a curtain coating method, a spin coating method, and a ring method. Among them, a dip coating method is preferred from the viewpoints of efficiency and productivity.

Process Cartridge and Electrophotographic Apparatus

FIG. 2 illustrates an example of a schematic configuration of an electrophotographic apparatus including a process cartridge including the electrophotographic photosensitive member according to the present invention.

The electrophotographic apparatus illustrated in FIG. 2 includes a cylindrical electrophotographic photosensitive member 1, and is rotatably driven at a predetermined peripheral velocity in the arrow direction about a shaft 2. A surface (circumferential surface) of the electrophotographic photosensitive member 1 rotatably driven is uniformly charged to a predetermined positive or negative potential by a charging unit 3 (primary charging unit: charging roller or the like). Subsequently, the uniformly charged surface of the electrophotographic photosensitive member 1 is exposed to exposure light (image exposure light) 4 emitted from an exposing unit (not illustrated) such as slit exposure light or laser beam scanning exposure light. Thus, electrostatic latent images corresponding to target images are sequentially formed on the surface of the electrophotographic photosensitive member 1.

The electrostatic latent image formed on the surface of the electrophotographic photosensitive member 1 is then developed by a toner contained in a developer of a developing unit 5 to be a toner image. Subsequently, the toner images formed and carried on the surface of the electrophotographic photosensitive member 1 are sequentially transferred onto a transfer material (paper or the like) P by a transfer bias from a transfer unit (transfer roller or the like) 6. The transfer material P is extracted from a transfer material feeding unit (not illustrated) and fed to a portion (contact portion) between the electrophotographic photosensitive member 1 and the transfer unit 6 in synchronization with the rotation of the electrophotographic photosensitive member 1.

The transfer material P on which the toner image is transferred is separated from the surface of the electrophotographic photosensitive member 1 and introduced to a fixing unit 8 to fix the image, thereby being discharged outside the apparatus as an image formation product (print or copy).

The surface of the electrophotographic photosensitive member 1 after the transfer of the toner image is cleaned by removing a transfer residual developer (transfer residual toner) by a cleaning unit (cleaning blade or the like) 7. Subsequently, the cleaned surface of the electrophotographic photosensitive member 1 is subjected to electricity removal by pre-exposure (not illustrated) from a pre-exposing unit (not illustrated), and then repeatedly used for forming an image. As illustrated in FIG. 2, in a case where the charging unit 3 is a contact charging unit using a charging roller or the like, the pre-exposure is not necessary.

A plurality of components selected from the components such as the electrophotographic photosensitive member 1, the charging unit 3, the developing unit 5, the transfer unit 6, and the cleaning unit 7 are stored in a container and integrally supported as a process cartridge 9. The process cartridge 9 can be configured to be detachably attachable to a main body of the electrophotographic apparatus such as a copy machine or a laser beam printer. In FIG. 2, the electrophotographic photosensitive member 1, the charging unit 3, the developing unit 5, and the cleaning unit 7 are integrally supported and formed as a cartridge, and used as the process cartridge 9 detachably attachable to the main body of the electrophotographic apparatus using a guiding unit 10 such as a rail of the main body of the electrophotographic apparatus.

### EXAMPLES

Hereinafter, although the present invention will be described in more detail by examples and comparative examples, the present invention is not limited to these examples. In the examples and the comparative examples, “part(s)” refer to “part(s) by mass”.

### Example 1

An aluminum cylinder having a length of 260.5 mm and a diameter of 30 mm (JIS H 4000:2006 A3003P, aluminum alloy) was prepared. The aluminum cylinder was subjected to cutting (JIS B 0601:2014, 10-point average roughness Rzjis: 0.8 μm), and the cut aluminum cylinder was used as a support (electroconductive support).

Next, 100 parts of untreated rutile-type titanium oxide particles (average primary particle size: 50 nm, manufactured by TAYCA CORPORATION) were stirred and mixed with 400 parts of methanol and 100 parts of methyl ethyl ketone, and 5.0 parts of vinyltrimethoxysilane was added. Thereafter, the mixture was subjected to a dispersion treatment with a vertical sand mill by using glass beads having a diameter of 1.0 mm for 8 hours. After the glass beads were removed, methanol and methyl ethyl ketone were distilled off by distillation under reduced pressure and dried at 120° C. for 3 hours, thereby obtaining rutile-type titanium oxide particles having been subjected to a surface treatment with an organic silicon compound.

Next, the following materials were prepared.
16.2 parts of the rutile-type titanium oxide particles having been subjected to the surface treatment with the organic silicon compound obtained as described above
4.5 parts of N-methoxymethylated nylon (trade name: Toresin EF-30T, manufactured by Nagase ChemteX Corporation)
1.5 parts of a copolymer nylon resin (trade name: Amilan CM8000, manufactured by Toray Industries Inc.)

These materials were added to a solvent in which 90 parts of methanol and 60 parts of 1-butanol were mixed with each other, thereby preparing a dispersion liquid.

The dispersion liquid was subjected to a dispersion treatment with a vertical sand mill by using glass beads having a diameter of 1.0 mm for 5 hours, and the glass beads were removed, thereby preparing a coating liquid for an undercoat layer. The coating liquid for an undercoat layer was applied onto the support by dip coating to form a coating film, and the obtained coating film was dried at 100° C. for 10 minutes, thereby forming an undercoat layer having a film thickness of 1.8 μm.

In the undercoat layer, the respective parameters were as follows.
A ratio a [−] of a volume of titanium oxide particles to a volume of a polyamide resin: 0.70
An average primary particle size b [μm] of titanium oxide particles having been subjected to a surface treatment with an organic silicon compound: 0.050
A mass ratio c [mass %] of a Si element to TiO₂ in the titanium oxide particles having been subjected to the surface treatment with the organic silicon compound: 0.70
A film thickness d [μm]: 1.8
A hydrophobized degree α [%] of the titanium oxide particles having been subjected to the surface treatment with the organic silicon compound: 45
a/b=14.0
b×c=0.035

A value of a was calculated by measuring methanol wettability of the titanium oxide particles having been subjected to the surface treatment with the organic silicon compound. The measurement of the methanol wettability was performed as described below using a powder wettability tester (trade name: WET100P, manufactured by RHESCA CO., LTD.). To a 200 ml beaker, 0.2 g of the titanium oxide particles having been subjected to the surface treatment with the organic silicon compound and 50 g of ion exchange water were added, and methanol was added dropwise while slowly stirring the beaker using a burette. When a dropping amount of methanol at which a light transmittance of the inside of the beaker was 10% was t, the value of the hydrophobized degree α was calculated from α=100×t/(t+50).

The value of a was calculated by producing an electrophotographic photosensitive member, and then obtaining a cross section of the electrophotographic photosensitive member from a micrograph using a field emission scanning electron microscope (FE-SEM, trade name: S-4800, manufactured by Hitachi High-Technologies Corporation).

A value of c was calculated as follows. First, rutile-type titanium oxide particles having been subjected to a surface treatment were produced, and then the particles were analyzed using a wavelength dispersion type fluorescence X-ray analyzer (XRF, trade name: Axios advanced, manufactured by PANalytical Inc.). From the obtained results, it was assumed that a Ti element detected was an oxide, and a content (mass %) of a Si element to TiO₂ was calculated with software (Spectra Evaluation, version 5.0 L).

Next, the following materials were prepared.
1 part of a metal-free phthalocyanine crystal (charge generating substance) represented by the following Formula (S3)
15 parts of a hole transporting substance represented by the following Formula (S4)
8 parts of an electron transporting substance represented by the following Formula (S5)
2 parts of an electron transporting substance represented by the following Formula (S6)
20 parts of a Z-type polycarbonate resin (trade name: IUPIZETA PCZ-400, manufactured by Mitsubishi Gas Chemical Company, Inc.)

These materials were added to 200 parts of tetrahydrofuran to prepare a dispersion liquid.

The dispersion liquid was subjected to a dispersion treatment with a ball mill by using glass beads having a diameter of 1.0 mm for 48 hours, and the glass beads were removed, thereby preparing a coating liquid for a photosensitive layer. The coating liquid for a photosensitive layer was applied onto the undercoat layer by dip coating to form a coating film, and the obtained coating film was dried at 120° C. for 60 minutes, thereby forming a photosensitive layer having a film thickness of 30 μm.

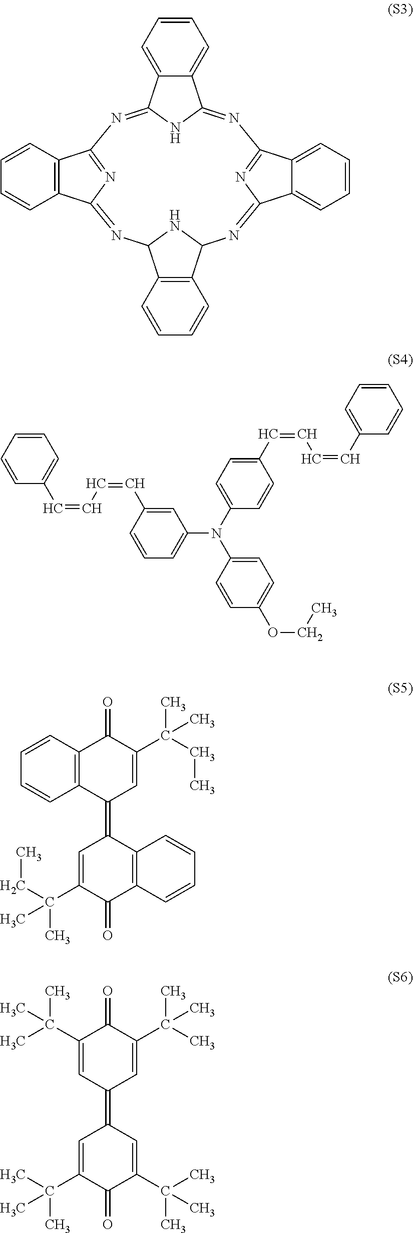 [SMILES: c1ccc2c(c1)C1=NC/2=N\C2NC(/N=C3N=C(/N=c4\[nH]/c(c5ccccc45)=N\1)c1ccccc1\3)c1ccccc12 ; CCOc1ccc(N(c2ccc(/C=C\C=C/c3ccccc3)cc2)c2cccc(/C=C\C=C/c3ccccc3)c2)cc1 ; CCC(C)(C)C1=C/C(=C2/C=C(C(C)(C)CC)C(=O)c3ccccc32)c2ccccc2C1=O ; CC(C)(C)C1=CC(=C2C=C(C(C)(C)C)C(=O)C(C(C)(C)C)=C2)C=C(C(C)(C)C)C1=O]

As described above, an electrophotographic photosensitive member including the undercoat layer and the photosensitive layer formed on the support was produced.

Evaluation of Fogging Under High-Temperature and High-Humidity Environment

A laser beam printer (trade name: HP LaserJet Enterprise 600 M609dn, non-contact developing system, print speed: A4 portrait 71 sheets/min, manufactured by Hewlett-Packard Company) was modified and used as an evaluator. A process cartridge was modified so that charging to the electrophotographic photosensitive member was performed in a corona discharge manner.

The electrophotographic photosensitive member produced as described above was mounted in a process cartridge for HP LaserJet Enterprise 600 M609dn. In addition, the process cartridge was modified by removing a charging roller and providing a corona wire and a grid electrode so that the charging was performed by the corona discharge, and a potential probe (trade name: model 6000B-8, manufactured by Trek Japan) was mounted in a developing position.

Thereafter, a potential at the central portion (position corresponding to about 130 mm) of the electrophotographic photosensitive member was measured using a surface potential meter (trade name: model 344, manufactured by Trek Japan). For a surface potential of the electrophotographic photosensitive member, an applied voltage and a light intensity of image exposure were set so that an initial dark part potential (Vd₀) was +500 V, an initial bright part potential (Vl₀) was +150 V, and a developing bias was +300 V, under an environment of a temperature of 35° C. and a humidity of 80% RH.

In an exposure amount set in a state in which the potential probe was present in a portion of a developing machine, image formation of an image having a printing rate of 1% on a plain paper of an A4 size was performed on 50,000 sheets under an environment of a temperature of 35° C. and a humidity of 80% RH. The image formation was performed in an intermittent mode in which printing was suspended every time the images were formed on three sheets.

The image formation was performed on 50,000 sheets, and then the electrophotographic photosensitive member in which the image formation was performed was mounted in a new process cartridge. The process cartridge was modified as those described above.

For a surface potential of the electrophotographic photosensitive member, an applied voltage and a light intensity of image exposure were set so that an initial dark part potential (Vd₀) was +500 V, an initial bright part potential (Vl₀) was +150 V, and a developing bias was +450V, under an environment of a temperature of 35° C. and a humidity of 80% RH.

The entire white image was printed under an environment of a temperature of 35° C. and a humidity of 80% RH, and the lowest value F₁ of a reflection density of a white portion of the entire white image and a reflection average density F₀ of the plain paper before the image formation were measured. A reflectometer (trade name: TC-6DS, manufactured by Tokyo Denshoku Co., Ltd.) was used for the measurement of the reflection density. A value calculated by |F₁−F₀| was defined as a fogging value, and the value was evaluated by the following criteria. The smaller the fogging value, the higher the fogging suppression effect. In the evaluation criteria of the present invention, each of A to C was regarded as a preferred level, and each of D and E was regarded as an unacceptable level.

A: The fogging value was less than 1.0.

B: The fogging value was 1.0 or more and less than 2.0.

C: The fogging value was 2.0 or more and less than 3.0.

D: The fogging value was 3.0 or more and less than 5.0.

E: The fogging value was 5.0 or more.

Evaluation of Potential Variation Under Low-Temperature and Low-Humidity Environment

A laser beam printer (trade name: HP LaserJet Enterprise 600 M609dn, non-contact developing system, print speed: A4 portrait 71 sheets/min, manufactured by Hewlett-Packard Company) was modified and used as an evaluator. A process cartridge was modified so that charging to the electrophotographic photosensitive member was performed in a corona discharge manner.

The electrophotographic photosensitive member produced as described above was mounted in a process cartridge for HP LaserJet Enterprise 600 M609dn. In addition, the process cartridge was modified by removing a charging roller and providing a corona wire and a grid electrode so that the charging was performed by the corona discharge, and a potential probe (trade name: model 6000B-8, manufactured by Trek Japan) was mounted in a developing position. Thereafter, a potential at the central portion (position corresponding to about 130 mm) of the electrophotographic photosensitive member was measured using a surface potential meter (trade name: model 344, manufactured by Trek Japan).

For a surface potential of the electrophotographic photosensitive member, an applied voltage and a light intensity of image exposure were set so that an initial dark part potential was +500 V, an initial bright part potential was +150 V, and a developing bias was +300 V, under an environment of a temperature of 15° C. and a humidity of 10% RH. In an exposure amount set in a state in which the potential probe was present in a portion of a developing machine, image formation of an image having a printing rate of 1% on a plain paper of an A4 size was performed on 50,000 sheets under an environment of a temperature of 15° C. and a humidity of 10% RH. The image formation was performed in an intermittent mode in which printing was suspended every time the images were formed on three sheets. Thereafter, a bright part potential (Vl_{f}) after repeated use was measured. A potential variation of the bright part potential (ΔVl=Vl_{f}−150 (unit: V)) is shown in Table 1. The smaller the value of ΔVl, the higher the effect of suppressing the potential variation.

### Example 2

In Example 1, the use amount of vinyltrimethoxysilane used in the preparation of the titanium oxide particles having been subjected to the surface treatment with the organic silicon compound was changed from 5.0 parts to 3.0 parts. Except for this, an electrophotographic photosensitive member was produced in the same manner as that of Example 1, and fogging and a potential variation were evaluated in the same manner as those of Example 1. The results are shown in Table 1.

### Example 3

In Example 1, the use amount of vinyltrimethoxysilane used in the preparation of the titanium oxide particles having been subjected to the surface treatment with the organic silicon compound was changed from 5.0 parts to 4.0 parts. Except for this, an electrophotographic photosensitive member was produced in the same manner as that of Example 1, and fogging and a potential variation were evaluated in the same manner as those of Example 1. The results are shown in Table 1.

### Example 4

In Example 1, the use amount of vinyltrimethoxysilane used in the preparation of the titanium oxide particles having been subjected to the surface treatment with the organic silicon compound was changed from 5.0 parts to 6.0 parts. Except for this, an electrophotographic photosensitive member was produced in the same manner as that of Example 1, and fogging and a potential variation were evaluated in the same manner as those of Example 1. The results are shown in Table 1.

### Example 5

Titanium oxide particles having been subjected to a surface treatment with an organic silicon compound were prepared as described below.

100 parts of untreated rutile-type titanium oxide particles (average primary particle size: 50 nm, manufactured by TAYCA CORPORATION) were stirred and mixed with 500 parts of toluene, 5.0 parts of vinyltrimethoxysilane was added, and the mixture was stirred with a stirrer for 8 hours. Thereafter, the toluene was distilled off by distillation under reduced pressure and dried at 120° C. for 3 hours, thereby obtaining rutile-type titanium oxide particles having been subjected to a surface treatment with an organic silicon compound.

Except for this, an electrophotographic photosensitive member was produced in the same manner as that of Example 1, and fogging and a potential variation were evaluated in the same manner as those of Example 1. The results are shown in Table 1.

### Example 6

In Example 1, 5.0 parts of vinyltrimethoxysilane used in the preparation of the titanium oxide particles having been subjected to the surface treatment with the organic silicon compound was changed to 6.0 parts of n-propyltrimethoxysilane. Except for this, an electrophotographic photosensitive member was produced in the same manner as that of Example 1, and fogging and a potential variation were evaluated in the same manner as those of Example 1. The results are shown in Table 1.

### Example 7

In Example 1, 5.0 parts of vinyltrimethoxysilane used in the preparation of the titanium oxide particles having been subjected to the surface treatment with the organic silicon compound was changed to 5.5 parts of isobutyltrimethoxysilane. Except for this, an electrophotographic photosensitive member was produced in the same manner as that of Example 1, and fogging and a potential variation were evaluated in the same manner as those of Example 1. The results are shown in Table 1.

### Example 8

A coating liquid for an undercoat layer was prepared as described below. 100 parts of untreated rutile-type titanium oxide particles (average primary particle size: 15 nm, manufactured by TAYCA CORPORATION) were stirred and mixed with 400 parts of methanol and 100 parts of methyl ethyl ketone, and 15.0 parts of vinyltrimethoxysilane was added. Thereafter, the mixture was subjected to a dispersion treatment with a vertical sand mill by using glass beads having a diameter of 1.0 mm for 8 hours. After the glass beads were removed, methanol and methyl ethyl ketone were distilled off by distillation under reduced pressure and dried at 120° C. for 3 hours, thereby obtaining rutile-type titanium oxide particles having been subjected to a surface treatment with an organic silicon compound.

Next, the following materials were prepared.
12.0 parts of the rutile-type titanium oxide particles having been subjected to the surface treatment with the organic silicon compound obtained as described above
9.0 parts of N-methoxymethylated nylon (trade name: Toresin EF-30T, manufactured by Nagase ChemteX Corporation)
3.0 parts of a copolymer nylon resin (trade name: Amilan CM8000, manufactured by Toray Industries Inc.)

These materials were added to a solvent in which 90 parts of methanol and 60 parts of 1-butanol were mixed with each other, thereby preparing a dispersion liquid.

The dispersion liquid was subjected to a dispersion treatment with a vertical sand mill by using glass beads having a diameter of 1.0 mm for 5 hours, and the glass beads were removed, thereby preparing a coating liquid for an undercoat layer.

Except for this, an electrophotographic photosensitive member was produced in the same manner as that of Example 1, and fogging and a potential variation were evaluated in the same manner as those of Example 1. The results are shown in Table 1.

### Example 9

A coating liquid for an undercoat layer was prepared as described below.

100 parts of untreated rutile-type titanium oxide particles (average primary particle size: 35 nm, manufactured by TAYCA CORPORATION) were stirred and mixed with 400 parts of methanol and 100 parts of methyl ethyl ketone, and 6.5 parts of vinyltrimethoxysilane was added. Thereafter, the mixture was subjected to a dispersion treatment with a vertical sand mill by using glass beads having a diameter of 1.0 mm for 8 hours. After the glass beads were removed, methanol and methyl ethyl ketone were distilled off by distillation under reduced pressure and dried at 120° C. for 3 hours, thereby obtaining rutile-type titanium oxide particles having been subjected to a surface treatment with an organic silicon compound.

Next, the following materials were prepared.
16.0 parts of the rutile-type titanium oxide particles having been subjected to the surface treatment with the organic silicon compound obtained as described above
6.0 parts of N-methoxymethylated nylon (trade name: Toresin EF-30T, manufactured by Nagase ChemteX Corporation)
2.0 parts of a copolymer nylon resin (trade name: Amilan CM8000, manufactured by Toray Industries Inc.)

These materials were added to a solvent in which 90 parts of methanol and 60 parts of 1-butanol were mixed with each other, thereby preparing a dispersion liquid.

The dispersion liquid was subjected to a dispersion treatment with a vertical sand mill by using glass beads having a diameter of 1.0 mm for 5 hours, and the glass beads were removed, thereby preparing a coating liquid for an undercoat layer.

Except for this, an electrophotographic photosensitive member was produced in the same manner as that of Example 1, and fogging and a potential variation were evaluated in the same manner as those of Example 1. The results are shown in Table 1.

### Example 10

A coating liquid for an undercoat layer was prepared as described below.

100 parts of untreated rutile-type titanium oxide particles (average primary particle size: 80 nm, manufactured by TAYCA CORPORATION) were stirred and mixed with 400 parts of methanol and 100 parts of methyl ethyl ketone, and 3.0 parts of vinyltrimethoxysilane was added. Thereafter, the mixture was subjected to a dispersion treatment with a vertical sand mill by using glass beads having a diameter of 1.0 mm for 8 hours. After the glass beads were removed, methanol and methyl ethyl ketone were distilled off by distillation under reduced pressure and dried at 120° C. for 3 hours, thereby obtaining rutile-type titanium oxide particles having been subjected to a surface treatment with an organic silicon compound.

Next, the following materials were prepared.
19.2 parts of the rutile-type titanium oxide particles having been subjected to the surface treatment with the organic silicon compound obtained as described above
3.6 parts of N-methoxymethylated nylon (trade name: Toresin EF-30T, manufactured by Nagase ChemteX Corporation)
1.2 parts of a copolymer nylon resin (trade name: Amilan CM8000, manufactured by Toray Industries Inc.)

These materials were added to a solvent in which 90 parts of methanol and 60 parts of 1-butanol were mixed with each other, thereby preparing a dispersion liquid.

The dispersion liquid was subjected to a dispersion treatment with a vertical sand mill by using glass beads having a diameter of 1.0 mm for 5 hours, and the glass beads were removed, thereby preparing a coating liquid for an undercoat layer.

Except for this, an electrophotographic photosensitive member was produced in the same manner as that of Example 1, and fogging and a potential variation were evaluated in the same manner as those of Example 1. The results are shown in Table 1.

### Example 11

A coating liquid for an undercoat layer was prepared as described below.

First, the following materials were prepared.
16.0 parts of the rutile-type titanium oxide particles having been subjected to the surface treatment with the organic silicon compound produced in Example 1
6.0 parts of N-methoxymethylated nylon (trade name: Toresin EF-30T, manufactured by Nagase ChemteX Corporation)
2.0 parts of a copolymer nylon resin (trade name: Amilan CM8000, manufactured by Toray Industries Inc.)

These materials were added to a solvent in which 90 parts of methanol and 60 parts of 1-butanol were mixed with each other, thereby preparing a dispersion liquid.

The dispersion liquid was subjected to a dispersion treatment with a vertical sand mill by using glass beads having a diameter of 1.0 mm for 5 hours, and the glass beads were removed, thereby preparing a coating liquid for an undercoat layer.

Except for this, an electrophotographic photosensitive member was produced in the same manner as that of Example 1, and fogging and a potential variation were evaluated in the same manner as those of Example 1. The results are shown in Table 1.

### Example 12

A coating liquid for an undercoat layer was prepared as described below.

First, the following materials were prepared.
17.3 parts of the rutile-type titanium oxide particles having been subjected to the surface treatment with the organic silicon compound produced in Example 1
5.4 parts of N-methoxymethylated nylon (trade name: Toresin EF-30T, manufactured by Nagase ChemteX Corporation)
1.8 parts of a copolymer nylon resin (trade name: Amilan CM8000, manufactured by Toray Industries Inc.)

These materials were added to a solvent in which 90 parts of methanol and 60 parts of 1-butanol were mixed with each other, thereby preparing a dispersion liquid.

The dispersion liquid was subjected to a dispersion treatment with a vertical sand mill by using glass beads having a diameter of 1.0 mm for 5 hours, and the glass beads were removed, thereby preparing a coating liquid for an undercoat layer.

Except for this, an electrophotographic photosensitive member was produced in the same manner as that of Example 1, and fogging and a potential variation were evaluated in the same manner as those of Example 1. The results are shown in Table 1.

### Example 13

A coating liquid for an undercoat layer was prepared as described below.

First, the following materials were prepared.
18.0 parts of the rutile-type titanium oxide particles having been subjected to the surface treatment with the organic silicon compound produced in Example 1
4.5 parts of N-methoxymethylated nylon (trade name: Toresin EF-30T, manufactured by Nagase ChemteX Corporation)
1.5 parts of a copolymer nylon resin (trade name: Amilan CM8000, manufactured by Toray Industries Inc.)

These materials were added to a solvent in which 90 parts of methanol and 60 parts of 1-butanol were mixed with each other, thereby preparing a dispersion liquid.

The dispersion liquid was subjected to a dispersion treatment with a vertical sand mill by using glass beads having a diameter of 1.0 mm for 5 hours, and the glass beads were removed, thereby preparing a coating liquid for an undercoat layer.

Except for this, an electrophotographic photosensitive member was produced in the same manner as that of Example 1, and fogging and a potential variation were evaluated in the same manner as those of Example 1. The results are shown in Table 1.

### Example 14

A coating liquid for an undercoat layer was prepared as described below.

First, the following materials were prepared.
10.2 parts of the rutile-type titanium oxide particles having been subjected to the surface treatment with the organic silicon compound produced in Example 8
9.6 parts of N-methoxymethylated nylon (trade name: Toresin EF-30T, manufactured by Nagase ChemteX Corporation)
3.2 parts of a copolymer nylon resin (trade name: Amilan CM8000, manufactured by Toray Industries Inc.)

These materials were added to a solvent in which 90 parts of methanol and 60 parts of 1-butanol were mixed with each other, thereby preparing a dispersion liquid.

The dispersion liquid was subjected to a dispersion treatment with a vertical sand mill by using glass beads having a diameter of 1.0 mm for 5 hours, and the glass beads were removed, thereby preparing a coating liquid for an undercoat layer.

Except for this, an electrophotographic photosensitive member was produced in the same manner as that of Example 8, and fogging and a potential variation were evaluated in the same manner as those of Example 1. The results are shown in Table 1.

### Examples 15 to 18

In Example 1, the film thickness d [μm] of the undercoat layer was changed as shown in Table 1. Except for this, an electrophotographic photosensitive member was produced in the same manner as that of Example 1, and fogging and a potential variation were evaluated in the same manner as those of Example 1. The results are shown in Table 1.

### Example 19

An undercoat layer was prepared as described below.

100 parts of untreated rutile-type titanium oxide particles (average primary particle size: 35 nm, manufactured by TAYCA CORPORATION) were stirred and mixed with 400 parts of methanol and 100 parts of methyl ethyl ketone, and 7.0 parts of n-propyltrimethoxysilane was added. Thereafter, the mixture was subjected to a dispersion treatment with a vertical sand mill by using glass beads having a diameter of 1.0 mm for 8 hours. After the glass beads were removed, methanol and methyl ethyl ketone were distilled off by distillation under reduced pressure and dried at 120° C. for 3 hours, thereby obtaining rutile-type titanium oxide particles having been subjected to a surface treatment with an organic silicon compound.

Next, the following materials were prepared.
15.8 parts of the rutile-type titanium oxide particles having been subjected to the surface treatment with the organic silicon compound obtained as described above
6.6 parts of N-methoxymethylated nylon (trade name: Toresin EF-30T, manufactured by Nagase ChemteX Corporation)
2.2 parts of a copolymer nylon resin (trade name: Amilan CM8000, manufactured by Toray Industries Inc.)

These materials were added to a solvent in which 90 parts of methanol and 60 parts of 1-butanol were mixed with each other, thereby preparing a dispersion liquid.

The dispersion liquid was subjected to a dispersion treatment with a vertical sand mill by using glass beads having a diameter of 1.0 mm for 5 hours, and the glass beads were removed, thereby preparing a coating liquid for an undercoat layer. The coating liquid for an undercoat layer was applied onto the support by dip coating to form a coating film, and the obtained coating film was dried at 100° C. for 10 minutes, thereby forming an undercoat layer having a film thickness of 1.5 μm.

Except for this, an electrophotographic photosensitive member was produced in the same manner as that of Example 1, and fogging and a potential variation were evaluated in the same manner as those of Example 1. The results are shown in Table 1.

### Comparative Example 1

In Example 5, the use amount of vinyltrimethoxysilane used in the preparation of the titanium oxide particles having been subjected to the surface treatment with the organic silicon compound was changed from 5.0 parts to 2.5 parts. Except for this, an electrophotographic photosensitive member was produced in the same manner as that of Example 5, and fogging and a potential variation were evaluated in the same manner as those of Example 1. The results are shown in Table 1.

### Comparative Example 2

Rutile-type titanium oxide particles having been subjected to a surface treatment with an organic silicon compound were produced as follows.

100 parts of untreated rutile-type titanium oxide particles (average primary particle size: 50 nm, manufactured by TAYCA CORPORATION) were dried at 100° C. for 10 minutes while performing stirring and mixing with a Henschel mixer. Thereafter, 3.0 parts of vinyltrimethoxysilane was sprayed with nitrogen gas over 1 hour while performing heating and stirring at 80° C. to obtain rutile-type titanium oxide particles having been subjected to the surface treatment with the organic silicon compound.

Except for this, an electrophotographic photosensitive member was produced in the same manner as that of Example 1, and fogging and a potential variation were evaluated in the same manner as those of Example 1. The results are shown in Table 1.

### Comparative Example 3

In Example 5, 5.0 parts of vinyltrimethoxysilane used in the preparation of the rutile-type titanium oxide particles having been subjected to the surface treatment with the organic silicon compound was changed to 5.0 parts of methyltrimethoxysilane. Except for this, an electrophotographic photosensitive member was produced in the same manner as that of Example 5, and fogging and a potential variation were evaluated in the same manner as those of Example 1. The results are shown in Table 1.

### Comparative Example 4

In Example 5, 5.0 parts of vinyltrimethoxysilane used in the preparation of the titanium oxide particles having been subjected to the surface treatment with the organic silicon compound was changed to 5.0 parts of octyltrimethoxysilane. Except for this, an electrophotographic photosensitive member was produced in the same manner as that of Example 5, and fogging and a potential variation were evaluated in the same manner as those of Example 1. The results are shown in Table 1.

### Comparative Example 5

A coating liquid for an undercoat layer was prepared as described below.

100 parts of rutile-type titanium oxide particles having been subjected to a surface treatment with silica and alumina (average primary particle size: 10 nm, manufactured by TAYCA CORPORATION) were stirred and mixed with 500 parts of toluene, 1.0 part of methylhydrogenpolysiloxane was added, and the mixture was stirred with a stirrer for 8 hours. Thereafter, the toluene was distilled off by distillation under reduced pressure and dried at 120° C. for 3 hours, thereby obtaining rutile-type titanium oxide particles having been subjected to a surface treatment with an organic silicon compound.

18.0 parts of the rutile-type titanium oxide particles having been subjected to the surface treatment with the organic silicon compound obtained as described above and 6.0 parts of a copolymer nylon resin (trade name: X1010, manufactured by Daicel-Evonik Ltd.) were added to a solvent in which 90 parts of methanol and 60 parts of 1-butanol were mixed with each other, thereby preparing a dispersion liquid.

The dispersion liquid was subjected to a dispersion treatment with a vertical sand mill by using glass beads having a diameter of 1.0 mm for 5 hours, and the glass beads were removed, thereby preparing a coating liquid for an undercoat layer. Except for this, an electrophotographic photosensitive member was produced in the same manner as that of Example 17, and fogging and a potential variation were evaluated in the same manner as those of Example 1. The results are shown in Table 1.

### Comparative Example 6

Titanium oxide particles having been subjected to a surface treatment with an organic silicon compound were produced as follows.

100 parts of rutile-type titanium oxide particles having been subjected to a surface treatment with silica and alumina (average primary particle size: 35 nm, manufactured by TAYCA CORPORATION) were stirred and mixed with 500 parts of toluene, 2.0 parts of methylhydrogenpolysiloxane was added, and the mixture was stirred with a stirrer for 8 hours. Thereafter, the toluene was distilled off by distillation under reduced pressure and dried at 120° C. for 3 hours, thereby obtaining rutile-type titanium oxide particles having been subjected to a surface treatment with an organic silicon compound.

Except for this, an electrophotographic photosensitive member was produced in the same manner as that of Comparative Example 5, and fogging and a potential variation were evaluated in the same manner as those of Example 1. The results are shown in Table 1.

TABLE 1

| | Organic silicon compound | | | | | | | | Evaluation | |
|---|---|---|---|---|---|---|---|---|---|---|
| | used for surface treatment | Parameter | | | | | | | Fogging | Potential |
| | of titanium oxide particle | a [−] | b [μm] | c [%] | d [μm] | α [%] | α/b | b × c | value | variation |
| Example 1 | Vinyltrimethoxysilane | 0.70 | 0.050 | 0.70 | 1.8 | 45 | 14.0 | 0.035 | A | 36 |
| Example 2 | Vinyltrimethoxysilane | 0.70 | 0.050 | 0.52 | 1.8 | 17 | 14.0 | 0.026 | C | 24 |
| Example 3 | Vinyltrimethoxysilane | 0.70 | 0.050 | 0.60 | 1.8 | 35 | 14.0 | 0.030 | A | 33 |
| Example 4 | Vinyltrimethoxysilane | 0.70 | 0.050 | 0.75 | 1.8 | 50 | 14.0 | 0.038 | A | 38 |
| Example 5 | Vinyltrimethoxysilane | 0.70 | 0.050 | 0.54 | 1.8 | 26 | 14.0 | 0.027 | C | 28 |
| Example 6 | n-Propyltrimethoxysilane | 0.70 | 0.050 | 0.52 | 1.8 | 85 | 14.0 | 0.026 | B | 38 |
| Example 7 | Isobutyltrimethoxysilane | 0.70 | 0.050 | 0.50 | 1.8 | 88 | 14.0 | 0.025 | B | 41 |
| Example 8 | Vinyltrimethoxysilane | 0.26 | 0.015 | 2.35 | 1.8 | 51 | 17.3 | 0.035 | B | 32 |
| Example 9 | Vinyltrimethoxysilane | 0.52 | 0.035 | 0.96 | 1.8 | 41 | 14.9 | 0.034 | A | 35 |
| Example 10 | Vinyltrimethoxysilane | 1.04 | 0.080 | 0.47 | 1.8 | 35 | 13.0 | 0.038 | A | 36 |
| Example 11 | Vinyltrimethoxysilane | 0.52 | 0.050 | 0.70 | 1.8 | 45 | 10.4 | 0.035 | A | 47 |
| Example 12 | Vinyltrimethoxysilane | 0.62 | 0.050 | 0.70 | 1.8 | 45 | 12.5 | 0.035 | A | 39 |
| Example 13 | Vinyltrimethoxysilane | 0.78 | 0.050 | 0.70 | 1.8 | 45 | 15.6 | 0.035 | A | 34 |
| Example 14 | Vinyltrimethoxysilane | 0.21 | 0.015 | 2.35 | 1.8 | 51 | 13.8 | 0.035 | A | 37 |
| Example 15 | Vinyltrimethoxysilane | 0.70 | 0.050 | 0.70 | 0.5 | 45 | 14.0 | 0.035 | C | 26 |
| Example 16 | Vinyltrimethoxysilane | 0.70 | 0.050 | 0.70 | 1.0 | 45 | 14.0 | 0.035 | A | 32 |
| Example 17 | Vinyltrimethoxysilane | 0.70 | 0.050 | 0.70 | 3.0 | 45 | 14.0 | 0.035 | A | 39 |
| Example 18 | Vinyltrimethoxysilane | 0.70 | 0.050 | 0.70 | 5.0 | 45 | 14.0 | 0.035 | A | 49 |
| Example 19 | n-Propyltrimethoxysilane | 0.47 | 0.035 | 0.70 | 1.5 | 76 | 13.3 | 0.025 | A | 30 |
| Comparative | Vinyltrimethoxysilane | 0.70 | 0.050 | 0.38 | 1.8 | 4 | 14.0 | 0.019 | D | 22 |
| Example 1 | | | | | | | | | | |
| Comparative | Vinyltrimethoxysilane | 0.70 | 0.050 | 0.46 | 1.8 | 0 | 14.0 | 0.023 | E | 19 |
| Example 2 | | | | | | | | | | |
| Comparative | Methyltrimethoxysilane | 0.70 | 0.050 | 0.37 | 2.0 | 0 | 14.0 | 0.019 | E | 20 |
| Example 3 | | | | | | | | | | |
| Comparative | Octyltrimethoxysilane | 0.70 | 0.050 | 0.29 | 2.0 | 78 | 14.0 | 0.015 | D | 25 |
| Example 4 | | | | | | | | | | |
| Comparative | Methylhydrogenpolysiloxane | 0.72 | 0.010 | 1.16 | 3.0 | 19 | 71.7 | 0.012 | A | 67 |
| Example 5 | | | | | | | | | | |
| Comparative | Methylhydrogenpolysiloxane | 0.72 | 0.035 | 2.21 | 3.0 | 37 | 20.5 | 0.077 | A | 80 |
| Example 6 | | | | | | | | | | |

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2019-239736, filed Dec. 27, 2019, which is hereby incorporated by reference herein in its entirety.

What is claimed is:

1. An electrophotographic photosensitive member comprising:
a support,
an undercoat layer, and
a photosensitive layer, in this order,
wherein the undercoat layer comprises:
a polyamide resin, and
titanium oxide particles having been subjected to a surface treatment with an organic silicon compound,
when an average primary particle size of the titanium oxide particles having been subjected to the surface treatment with the organic silicon compound is defined as “b” [μm], and a mass ratio of a Si element to TiO₂ in the titanium oxide particles having been subjected to the surface treatment with the organic silicon compound is defined as “c” [mass %], “b” and “c” satisfy a relationship expressed by the following Expression (B),
0.025≤b×c≤0.050 (B), and
the photosensitive layer is a monolayer type photosensitive layer comprising:
a charge generating substance,
a hole transporting substance, and
an electron transporting substance.

2. The electrophotographic photosensitive member according to claim 1, wherein the electron transporting substance is a compound represented by the following Formula (S7), 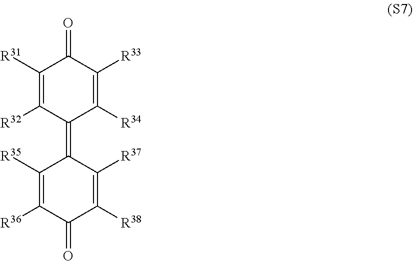
wherein each of R³¹ to R³⁸ represents:
a hydrogen atom,
a halogen atom,
an alkyl group which may be substituted with a halogen atom,
an aryl group which may be substituted with a halogen atom, or
an alkoxy carbonyl group which may be substituted with a halogen atom, or
R³¹ and R³², R³³ and R³⁴, R³⁵ and R³⁶, or R³⁷ and R³⁸ may be bonded to each other to form an aromatic ring which may be substituted with an alkyl group.

3. The electrophotographic photosensitive member according to claim 1, wherein the titanium oxide particles having been subjected to the surface treatment with the organic silicon compound has hydrophobized degree of 35 to 85%.

4. The electrophotographic photosensitive member according to claim 1, wherein when a ratio of a volume of the titanium oxide particles to a volume of the polyamide resin in the undercoat layer is defined as “a”, “a” and “b” satisfy a relationship expressed by the following Expression (A),
12.5≤a/b≤16.0 (A).

5. The electrophotographic photosensitive member according to claim 1, wherein the undercoat layer has film thickness of 1.0 to 3.0 μm.

6. The electrophotographic photosensitive member according to claim 1, wherein the titanium oxide particle has crystal system of rutile-type.

7. A process cartridge integrally supporting:
an electrophotographic photosensitive member, and
at least one unit selected from the group consisting of a charging unit, a developing unit, and a cleaning unit, and
the process cartridge being detachably attachable to a main body of an electrophotographic apparatus,
wherein the electrophotographic photosensitive member comprises:
a support,
an undercoat layer, and
a photosensitive layer, in this order,
the undercoat layer comprises:
a polyamide resin, and
titanium oxide particles having been subjected to a surface treatment with an organic silicon compound,
when an average primary particle size of the titanium oxide particles having been subjected to the surface treatment with the organic silicon compound is defined as “b” [μm], and a mass ratio of a Si element to TiO₂ in the titanium oxide particles having been subjected to the surface treatment with the organic silicon compound is defined as “c” [mass %], “b” and “c” satisfy a relationship expressed by the following Expression (B),
0.025≤b×c≤0.050 (B), and
the photosensitive layer is a monolayer type photosensitive layer comprising:
a charge generating substance,
a hole transporting substance, and
an electron transporting substance.

8. An electrophotographic apparatus comprising:
an electrophotographic photosensitive member,
a charging unit,
an exposing unit,
a developing unit, and
a transfer unit,
wherein the electrophotographic photosensitive member comprises:
a support,
an undercoat layer, and
a photosensitive layer, in this order,
the undercoat layer comprises:
a polyamide resin, and
titanium oxide particles having been subjected to a surface treatment with an organic silicon compound,
when an average primary particle size of the titanium oxide particles having been subjected to the surface treatment with the organic silicon compound is defined as “b” [μm], and a mass ratio of a Si element to TiO₂ in the titanium oxide particles having been subjected to the surface treatment with the organic silicon compound is defined as “c” [mass %], “b” and “c” satisfy a relationship expressed by the following Expression (B),
0.025≤b×c≤0.050 (B), and
the photosensitive layer is a monolayer type photosensitive layer comprising:
a charge generating substance,
a hole transporting substance, and
an electron transporting substance.
